(19) United States
(12) Patent Application Publication
(10) Pub. No.: US 2006/0218257 A1
(43) Pub. Date: Sep. 28, 2006

(54) Apparatus having network capability and method for assigning IP address

(75) Inventor: Hiroshi Kaibe, Hachiouji-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/386,321

(22) Filed: Mar. 22, 2006

(30) Foreign Application Priority Data
Mar. 25, 2005 (JP) P2005-089481

(51) Int. Cl. G06F 15/177

(52) U.S. Cl. 709/220

(57) ABSTRACT

An apparatus has network capability for communicating with other device through an IP network. The apparatus includes: a network interface that establishes a connection to the IP network; a DHCP address acquisition unit that acquires a first IP address pursuant to DHCP; an Auto IP address acquisition unit that acquires a second IP address pursuant to AutoIP; and a process controller that controls the DHCP address acquisition unit and the AutoIP address acquisition unit to substantially simultaneously start acquiring the first IP address and the second IP address, and assigns to the network interface either one of the first IP address and the second IP address in accordance with an acquisition state of the first IP address and an acquisition state of the second IP address, when establishing a connection to the IP network.

### CROSS-REFERENCE TO RELATED APPLICATIONS

This application is based upon and claims the benefit of priority from Japanese Patent Application No. 2005-089481, filed on Mar. 25, 2005, the entire contents of which are incorporated herein by reference.

### BACKGROUND

1. Field

One embodiment relates to an apparatus having network capability and a method for assigning an IP address, and, more particularly, to an apparatus having network capability which automatically assigns an IP address when the apparatus is connected to a network, as well as to a method for assigning the IP address.

2. Description of the Related Art

As methods for automatically assigning an IPv4 address, there have been provided a method for assigning an address pursuant to DHCP (Dynamic Host Configuration Protocol) specified in IETF RFC2131, and a method for dynamically assigning a link-local address, so-called AutoIP, specified in IETF RFC3927 (Dynamic Configuration of IPv4 Link-Local Addresses). The AutoIP is also referred to as “APIPA—Automatic Private IP Addressing”.

Address assignment pursuant to DHCP and Auto IP according to the related-art technique is performed by procedures described below. First, address acquisition based on DHCP is attempted, and, when this attempt succeeds, the thus-acquired address is employed. Meanwhile, when this address acquisition based on DHCP ends in failure, subsequently, an address is assigned pursuant to AutoIP.

For instance, JP-A-2003-273873 describes an electronic device which, at a time of assignment of an IP address, automatically determines whether or not to assign the IP address by itself pursuant to AutoIP, in accordance with a network address assigned to the electronic device.

However, the above-described related-art technique implements the following procedures: first, address assignment pursuant to DHCP is attempted; and, after this attempt is found to end in failure, the address is assigned pursuant to AutoIP. Accordingly, the technique involves a problem of lengthening a time required for address assignment.

In addition, in the electronic device disclosed in the document JP-A-2003-273873, whether or not to assign an address by itself pursuant to AutoIP is determined in accordance with its network address. Hence, this determination is made after obtaining the network address. As a result, a time required for the address assignment in the electronic device becomes lengthening.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing an IP address assignment function according to a first embodiment;

FIG. 2 is an exemplary state-transition diagram according to the first embodiment;

FIG. 3 is an explanatory view showing operation timing according to the first embodiment; and

FIG. 4 is an exemplary configuration diagram of an apparatus having network capability according to a second embodiment.

### DETAILED DESCRIPTION

Various embodiments according to the invention will be described hereinafter with reference to the accompanying drawings.

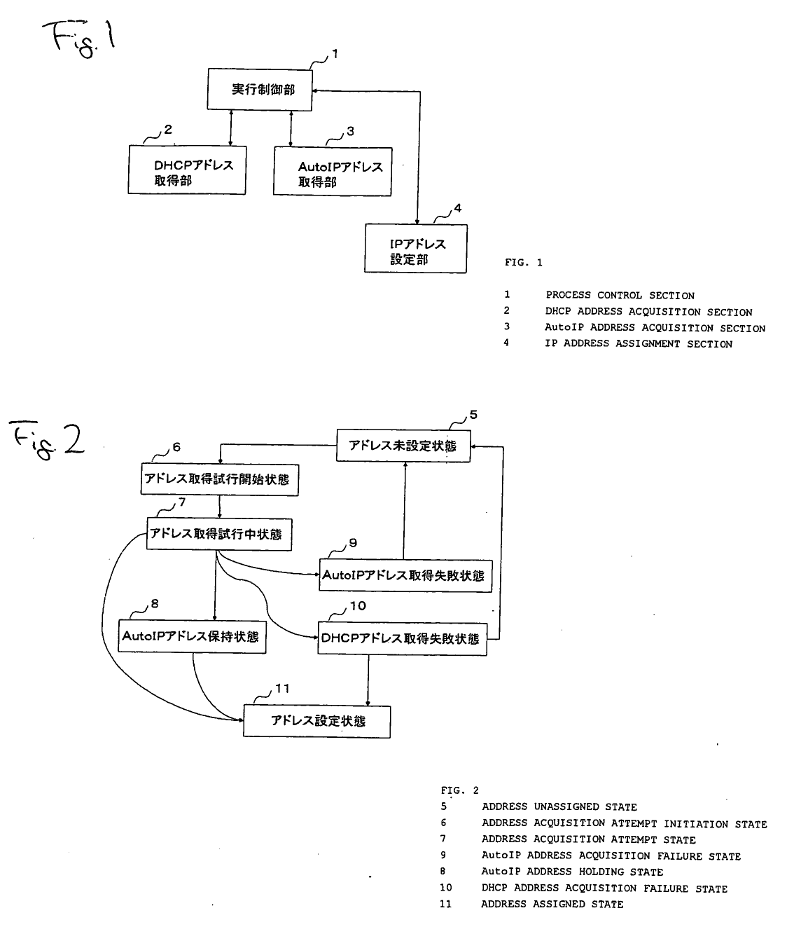

FIG. 1 is a block diagram showing an IP address assignment function according to a first embodiment.

A process control section 1 issues an initiation command or an interruption command to a DHCP address acquisition section 2. In a case where acquisition of an IP address pursuant to DHCP succeeds, the process control section 1 receives a response indicating successful address acquisition, and the thus-acquired IP address.

In a case where acquisition of an IP address pursuant to DHCP fails, the process control section 1 receives from the DHCP address acquisition section 2 a response indicating address acquisition failure.

The process control section 1 passes to an AutoIP address acquisition section 3 an initiation command or an interruption command. In a case where the acquisition of an IP address pursuant to AutoIP succeeds, the process control section 1 receives a response indicating successful address acquisition, and the thus-acquired IP address.

In a case where acquisition of an IP address pursuant to AutoIP is failed, the process control section 1 receives from the AutoIP address acquisition section 3 a response indicating address acquisition failure.

The DHCP address acquisition section 2 receives the initiation command provided from the process control section 1, and attempts to acquire an IP address in accordance with DCHP. In the case where the acquisition of an IP address in accordance with DCHP succeeds, the DHCP address acquisition section 2 passes, to the process control section 1, the thus-acquired IP address and a response indicating successful address acquisition.

Meanwhile, in a case where acquisition of an IP address has failed, the DHCP address acquisition section 2 passes to the process control section 1 a response indicating address acquisition failure.

In the case of receiving the interruption command from the process control section 1, the DHCP address acquisition section 2 interrupts the attempt to acquire an IP address in accordance with DCHP.

The AutoIP address acquisition section 3 receives the initiation command provided from the process control section 1, and attempts to acquire an IP address pursuant to AutoIP. In a case where the acquisition of an IP address pursuant to AutoIP succeeds, the AutoIP address acquisition section 3 passes, to the process control section 1, the thus-acquired IP address and a response indicating successful address acquisition.

Meanwhile, in the case where acquisition of an IP address has failed, the AutoIP address acquisition section 3 passes to the process control section 1 a response indicating address acquisition failure.

In the case of receiving the interruption command from the process control section 1, the AutoIP address acquisition section 3 interrupts the attempt to acquire an IP address pursuant to AutoIP.

An IP address assignment section 4 receives an IP address from the process control section 1, and assigns the thus-received IP address to an unillustrated network interface.

FIG. 2 is a state-transition diagram in relation to the embodiment. The embodiment is characterized by the process control section 1 concurrently executing passing of the initiation command to the DHCP address acquisition section 2, and passing of the initiation command to the AutoIP address acquisition section 3.

That is, the embodiment is characterized by a state management method employed by the process control section 1. The state management method employed by the process control section 1 will now be described.

An address unassigned state 5 is an initial state. The process control section 1 receives an address acquisition command issued by a user or an address acquisition command issued by a system, and thereupon the state changes to an address acquisition attempt initiation state 6.

In the address acquisition attempt initiation state 6, the process control section 1 passes an initiation command to each of the DCHP address acquisition section 2 and the AutoIP address acquisition section 3, and thereupon the state changes to an address acquisition attempt state 7.

In the address acquisition attempt state 7, the process control section 1 waits for a response from the DCHP address acquisition section 2 or the AutoIP address acquisition section 3, and the state changes to one of the four states which will be described hereinbelow, depending on the contents of the responses.
(1) In a case where a response indicating successful address acquisition and an IP address are received from the AutoIP address acquisition section, the state changes to an AutoIP address holding state 8.
(2) In a case where a response indicating successful address acquisition and an IP address are received from the DHCP address acquisition section 2, the process control section 1 passes an interruption command to the AutoIP acquisition section 3, passes the IP address to the IP address assignment section 4, and the state changes to an address assigned state 11 .
(3) In a case where a response indicating address acquisition failure is received from the AutoIP address acquisition section 3, the state changes to an AutoIP address acquisition failure state 9.
(4) In a case where a response indicating address acquisition failure is received from the DCHP address acquisition section 2, the state changes to a DHCP address acquisition failure state 10.

In the AutoIP address holding state 8 among the above states, the process control section 1 waits for a response from the DHCP address acquisition section 2, and passes to the IP address assignment section 4 either the IP address acquired pursuant to AutoIP or the IP address acquired pursuant to DHCP, depending on the content of the response. Hereinbelow, conditions for this transition will be described.
(1) In a case where the response indicating address acquisition failure is received, the process control section 1 passes, to the IP address assignment section 4, the IP address which is acquired pursuant to AutoIP and held at the time of transition to this state, thereupon the state changes to the address assigned state 11.
(2) In a case where the response indicating successful address acquisition success and the IP address acquired in accordance with DCHP are received from the DHCP address acquisition section 2, the process control section 1 passes the IP address acquired in accordance DHCP to the IP address assignment section 4, and thereupon the state changes to the address assigned state 11.

In the AutoIP address acquisition failure state 9, the process control section 1 waits for a response from the DCHP address acquisition section 2, and the state changes to either the address assigned state 11 or the address unassigned state 8, depending on the content of the response. Hereinbelow, conditions for this transition will be described.
(1) In a case where the response indicating successful address acquisition and the IP address are received from the DHCP address acquisition section 2, the process control section 1 passes the IP address to the IP address assignment section 4, and thereupon the state changes to the address assigned state 11.
(2) In a case where a response indicating address acquisition failure is received from the DHCP address acquisition section 2, the address assignment is found to have failed. Hence, the state transitions to the address unassigned state 8.

In the DHCP address acquisition failure state 10, the process control section 1 waits for a response from the AutoIP address acquisition section 3, and transitions either to the address assigned state or the address unassigned state, depending on the content of the response. Hereinbelow, conditions for this transition will be described.
(1) In a case where the response indicating successful address acquisition and the IP address are received from the AutoIP address acquisition section 3, the process control section 1 passes the IP address to the IP address assignment section 4, and thereupon the state changes to the address assigned state 11.
(2) In a case where a response indicating address acquisition failure is received from the AutoIP address acquisition section 3, the address assignment is found to have failed. Hence, the state transitions to the address unassigned state 8.

In the address assigned state 11 and the address unassigned state 8, each of which is a finished state, the process control section 1 does not transition before the same receives a command for re-assignment of an address from a user or the system. However, there may be adopted such a configuration that, in the case of falling into the address unassigned state 8, a command for re-assignment of an address is issued. In addition, there may be adopted such a configuration that, in the case of the address re-assignment, only address acquisition pursuant to AutoIP is attempted.

As is apparent from the above descriptions about the state transition, according to the present embodiment, an initiation command is transmitted to the DHCP address acquisition section 2 and to the AutoIP address acquisition section 3 in parallel during the address acquisition attempt initiation state 6 of the process control section 1. Depending on a responses to these commands, the state transitions to the address assigned state 11 where an address is assigned pursuant to DHCP or AutoIP or to the address unassigned state 5 resulting from a failure to assign an address.

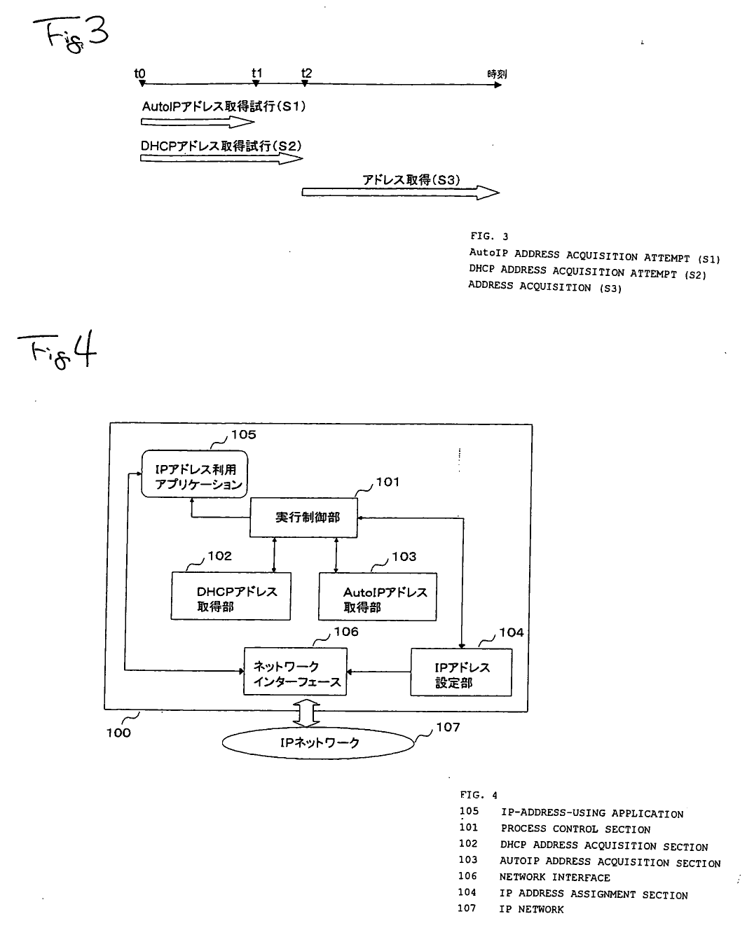

Next, operation timing according to the embodiment will be described by reference to FIG. 3.

FIG. 3 is an explanatory view showing operation timing in relation to an address acquisition attempt. FIG. 3 describes temporal transition of the address acquisition attempt under a situation where address assignment pursuant to DHCP fails and address assignment pursuant to AutoIP succeeds.

First, the address acquisition is initiated at a time t0, and address acquisition pursuant to DHCP and that pursuant to AutoIP are performed in parallel (S1, S2). Thereafter, the address acquisition pursuant to AutoIP completes at a time t1. Consequently, the state transitions to the AutoIP address holding state. Subsequently, when the attempt to acquire an address pursuant to DHCP is found to have failed at time t2, an IP address which has been acquired pursuant to AutoIP at this point in time becomes available (S3).

In the case of adopting the related-art technique, address acquisition processing pursuant to AutoIP is performed after an attempt to acquire an address pursuant to DHCP is found to have failed. Therefore, address acquisition pursuant to AutoIP is initiated at or after time t2, and a finalized IP address becomes available as a result of acquisition of the address. In contrast, according to the configuration of the embodiment, a time point at which an IP address becomes available is shortened to the duration from t0 to t2. Accordingly, an IP address becomes available within a short period of time after connection to the network is established.

Alternatively, there may be adopted such a configuration that an IP address is assigned to a network interface at timing t1 where the IP address can be acquired in the AutoIP address acquisition attempt (S1). In this case, switching to the address acquired pursuant to DHCP may be performed at the time point where the IP address acquisition in the DHCP address acquisition attempt (S2) is completed. Alternatively, when neither a user nor an application software which is currently used requires a connection to an external network other than the local network, the IP address acquired pursuant to AutoIP may be used continuously.

FIG. 4 is a configuration diagram of an apparatus having network capability on which an IP address assignment function according to a second embodiment is installed.

In FIG. 4, an apparatus 100 having network capability is an apparatus being capable of connecting to a computer network, such as the Internet. Examples of the apparatus 100 having network capability include a personal computer and network-capable home electrical appliances.

The apparatus 100 having network capability includes an process control section 101, a DHCP address acquisition section 102, an AutoIP address acquisition section 103, an IP address assignment section 104, an IP-address-using application 105, and a network interface 106.

The process control section 101, the DHCP address acquisition section 102, the AutoIP address acquisition section 103, and the IP address assignment section 104 have a functions identical with their counterparts in the first embodiment shown in FIG. 1; namely, the process control section 1, the DHCP address acquisition section 2, the AutoIP address acquisition section 3, and the IP address assignment section 4, and detailed descriptions thereof are omitted.

The IP-address-using application 105 is a program for carrying out network communication with use of an IP address. Generally-employed examples of the IP-address-using application 105 include a WWW browser and an electronic mail reader.

The network interface 106 is a target to which an IP address is assigned, and generally denotes a device serving as a gateway to a physical network, such as a network card.

Meanwhile, the network interface 106 may be configured as a logical configuration, such as a virtual network interface; and also in this case, the same advantages can be yielded by the invention.

An IP network 107 is a computer network in which communication route can be controlled with use of an IP address, and represents a local network installed in a home or an office, or a global network, such as the Internet.

During start-up of the apparatus 100 having network capability, the process control section 101 executes an IP address acquisition operation. Details of the operation are described in the first embodiment, and repeated descriptions thereof are omitted.

According to this configuration, an IP address acquired pursuant to DHCP or AutoIP is passed to the IP address assignment section 104.

The IP address assignment section 104 assigns the thus-passed IP address to the network interface 106 of the apparatus having network capability.

After the IP address is assigned to the network interface 106, the IP-address-using application 105 can carry out IP communication with other devices on the IP network 107 by way of the network interface 106.

The apparatus having network capability according to the embodiments; e.g., a personal computer or a home electrical appliance, can greatly shorten a time required for IP address assignment.

As a result, a time before a user can use the IP-address-using application 105, or the like, can be shortened.

As described above in detail with respect to the embodiment, procedures for address acquisition and address assignment are changed in accordance with an acquisition state of the first IP address (DHCP address) and an acquisition state of the second IP address (AutoIP address), thereby shortening a time required for address assignment in a apparatus having network capability.

It is to be understood that the present invention is not limited to the specific embodiment described above and that the present invention can be embodied with the components modified without departing from the spirit and scope of the invention. The present invention can be embodied in various forms according to appropriate combinations of the components disclosed in the embodiment described above. For example, some components may be deleted from all components shown in the embodiment. Further, the components in different embodiments may be used appropriately in combination.

What is claimed is:

1. An apparatus having network capability, the apparatus comprising:
a network interface that establishes a connection to an IP network for communicating with other device through the IP network;
a DHCP address acquisition unit that acquires a first IP address pursuant to DHCP;
an Auto IP address acquisition unit that acquires a second IP address pursuant to AutoIP; and
a process controller that controls the DHCP address acquisition unit and the AutoIP address acquisition unit to substantially simultaneously start acquiring the first IP address and the second IP address, and assigns to the network interface either one of the first IP address and the second IP address in accordance with an acquisition state of the first IP address and an acquisition state of the second IP address, when establishing a connection to the IP network.

2. The apparatus according to claim 1, wherein the process controller assigns the second IP address to the network interface when the DHCP address acquisition unit fails to acquire the first IP address after lapse of a first predetermined time.

3. The apparatus according to claim 2, wherein the process controller assigns the first IP address to the network interface when the DHCP address acquisition unit succeeds to acquire the first IP address after lapse of a second predetermined time that is longer than the first predetermined time.

4. A method for assigning an IP address for an apparatus having network capability for communicating with other device through an IP network, the method comprising:
acquiring a first IP address pursuant to DHCP;
acquiring a second IP address pursuant to AutoIP, being started substantially simultaneous with the acquiring of the first IP address; and
assigning, to a network interface that is provided in the apparatus for establishing a connection to the IP network, either one of the first IP address and the second IP address in accordance with an acquisition state of the first IP address and an acquisition state of the second IP address.

5. The method according to claim 4, wherein the second IP address is assigned to the network interface when the first IP address is failed to be acquired after lapse of a first predetermined time.

6. The method according to claim 5, further comprising assigning to the network interface the first IP address when the first IP address is acquired after lapse of a second predetermined time that is longer than the first predetermined time.
